(19) United States
(12) Patent Application Publication
(10) Pub. No.: US 2010/0327593 A1
(43) Pub. Date: Dec. 30, 2010

(54) APPARATUS FOR RECOVERY OF KINETIC ENERGY FROM MOVING WHEELED VEHICLES

(76) Inventor: Justin Campbell Robertson, Auckland (NZ)

Correspondence Address: KING & SCHICKLI, PLLC, 247 NORTH BROADWAY, LEXINGTON, KY, 40507, US

(21) Appl. No.: 12/865,289

(22) PCT Filed: Jan. 30, 2009
(86) PCT No.: PCT/IB09/00155

§ 371 Date: Jul. 29, 2010

(30) Foreign Application Priority Data
Jan. 30, 2008 (NZ) 560238

(51) Int. Cl. H02K 7/18

(52) U.S. Cl. 290/52

(57) ABSTRACT

The present invention relates to an apparatus for recovery of kinetic energy from moving wheeled vehicles which includes at least one fluid filled pipe capable of substantially collapsing on impact with the wheels of the vehicle to provide fluid displacement; at least one turbine for converting the fluid displacement from the at least one fluid filled pipe to mechanical movement; a gravity feed fluid reservoir positioned above the height of the at least one fluid filled pipe; a circuit capable of one-way fluid flow from the at least one fluid filled pipe to the at least one turbine generator unit and back to the at least one fluid filled pipe via the gravity feed fluid reservoir wherein the at least one fluid filled pipe is set diagonally to the vehicle's path of direction each of the fluid filled pipe is arranged in a loop with the open ends of the pipe in direct fluid communication to the circuit.

### STATEMENT OF CORRESPONDING APPLICATIONS

This application is based on the Provisional specification filed in relation to New Zealand Patent Application Number 560238, the entire contents of which are incorporated herein by reference.

### TECHNICAL FIELD

The present invention relates to an apparatus for recovery of kinetic energy from moving wheeled vehicles. In particular the present invention relates to an apparatus which utilises fluid dispersion from the impact of a vehicle on at least one fluid filled pipe.

### BACKGROUND ART

There is a need for sustainable and clean power generation technology as an alternative to traditional methods of power generation such as burning fossil fuels in the form of coal and oil which are associated with environmental problems due to emission of pollution, such as carbon dioxide.

Apparatus to generate kinetic energy from the motion of vehicles on a road or track are known. Such apparatus can provide a “clean” source of sustainable power, however practical application of such apparatus is still in its infancy.

WO9516133 outlines an apparatus consisting of a liquid filled pipe and mechanical pads which are impacted by passing vehicles to cause displacement of liquid within the pipes which can be used to drive a turbine and generator unit or dynamo.

A disadvantage with this apparatus and other similar mechanical apparatus is that the use of moving mechanical parts provides inefficiency in energy generation with significant energy lost in friction. In addition such mechanical parts are also prone to failure which results in maintenance problems especially if the part failing is in an area not readily accessible (for example beneath a road surface). In addition such mechanical apparatus are relatively expensive to produce and maintain.

U.S. Pat. No. 6,718,760 describes an apparatus for generating electrical energy from the kinetic energy of wheeled vehicles on a roadway including at least one fluid filled pressure vessel arranged substantially perpendicular to the roadway. This apparatus utilises the displacement of fluid from an impact of a vehicle with the pressure vessel to drive a turbine and electrical generator unit.

While the lack of mechanical parts solves the problem of mechanical failure the apparatus described in U.S. Pat. No. 6,718,760 has the disadvantage that the arrangement of at least one fluid filled pressure vessel in relation to the roadway does not produce an optimum fluid displacement from the impact of a vehicle on the pressure vessel and can also lead to a shortened lifespan of the said vessels as they have to take the full impact of the vehicle.

U.S. Pat. No. 4,409,498 describes an apparatus for the recovery of kinetic energy from moving wheeled vehicles utilising fluid filled tubes arranged diagonally to the path of direction of the vehicle. While this arrangement of fluid filled tubes meets the problem of optimum fluid displacement it still suffers from the disadvantage that the efficiency of recharge of fluid into the deformed tubes after impact with a moving vehicle is limited with consequent loss of efficiency of power generation in the overall apparatus.

It is an object of the present invention to solve the foregoing problems and provide an efficient and robust apparatus for the recovery of kinetic energy from moving vehicles.

Further aspects and advantages of the present invention will become apparent from the ensuing description which is given by way of example only.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used.

### DISCLOSURE OF INVENTION

According to one aspect of the present invention there is provided an apparatus for recovery of kinetic energy from moving wheeled vehicles comprising:
at least one fluid filled pipe capable of substantially collapsing on impact with the wheels of the vehicle to provide fluid displacement;
at least one turbine for converting the fluid displacement from the fluid filled pipe to mechanical movement;
a gravity feed fluid reservoir positioned above the height of the fluid filled pipe;
a circuit capable of one-way fluid flow from the fluid filled pipe to the turbine generator unit and back to the fluid filled pipe via the gravity feed fluid reservoir
   wherein
the fluid filled pipe is set diagonally to the vehicle's path of direction; and
each fluid filled pipe is arranged in a loop with the open ends of the pipe in direct fluid communication to the feed line.

According to another aspect of the present invention there is provided an apparatus for recovery of kinetic energy from moving wheeled vehicles comprising:
at least one fluid filled pipe capable of collapsing on impact with the wheels of the vehicle to provide fluid displacement;
at least one turbine to convert the fluid displacement from the fluid filled pipe to mechanical movement;
a gravity feed fluid reservoir positioned above the height of the fluid filled pipe;
at least one feed line fluidly connecting the fluid filled pipe to the at least one turbine;
a one-way outlet valve positioned between the fluid filled pipe and the feed line;
at least one return line from the turbine to the gravity feed fluid reservoir,
at least one one-way inlet valve positioned inside the gravity feed fluid reservoir and fluidly connected to the fluid filled pipe
   wherein
the fluid filled pipe is set diagonally to the vehicle's path of direction; and
each fluid filled pipe is arranged in a loop with the open ends of the pipe in direct fluid communication to the feed line.

Preferably, the apparatus for recovery of kinetic energy from moving wheeled vehicles also comprises at least one electrical generator to convert the mechanical movement of the turbine to electricity.

Preferably, the fluid filled pipe is a lay flat pipe.

Preferably, the fluid filled pipe may be integrated into an upper pressure sheet to form a contact surface for the wheels of the vehicle and distribute the pressure of the wheels of the vehicle laterally and longitudinally over the fluid filled pipe.

More preferably, the upper pressure sheet is made in a non-slip material such as a rubber based compound to prevent slippage of the vehicle on impact.

Preferably, the fluid filled pipe may be integrated into a backing mat.

Still more preferably, each backing mat may be integrated with 22 fluid filled pipes.

More preferably, the backing mat also comprises an inclined plane on the approach and/or exit to the backing mat to facilitate mounting and/or exit of the vehicle from the backing mat.

Preferably, the angle between the direction of the fluid filled pipe and the vehicle's path of direction is in the range 5° to 85°.

More preferably, the angle between the direction of the fluid filled pipe and the vehicle's path of direction is 60°.

Preferably, the loop of the fluid filled pipe is 1 metre in length.

Preferably, the width of the fluid filled pipe is 40 mm in width.

Preferably, each loop of each fluid filled pipe is fluidly connected to one feed line.

Preferably, the height of fluid level within the reservoir is at least 900 mm above the level of the at least one fluid filled pipe.

Preferably, where there are multiple turbines they are connected by a common axle.

Preferably, the turbine, the gravity feed fluid reservoir, the feed line, the return line and the electrical generator are contained within a portable housing.

Preferably, the feed line fluidly connects to the turbine at a feed nozzle.

Thus, preferred embodiments of the present invention have a number of advantages over the prior art which can include:
improved efficiency of energy recovery from fluid displacement within fluid filled pipes;
improved durability of the apparatus through a minimum of mechanical moving or electrical parts (such as fluid pumps);
improved ease of use through modular construction enabling for the combination of modules for any particular application;
relatively low cost of manufacture and maintenance; and
compatibility with unmodified vehicles.

### BRIEF DESCRIPTION OF DRAWINGS

Further aspects of the present invention will become apparent from the following description which is given by way of example only and with reference to the accompanying drawings in which:

FIG. 1 shows a plan view of a preferred embodiment of an apparatus for recovery of kinetic energy from moving wheeled vehicles;

FIG. 2 shows a side sectional view of the preferred embodiment shown in FIG. 1;

FIG. 3 shows a side view of the turbine with fluid inlet and output ports of the preferred embodiment shown in FIGS. 1 and 2;

FIG. 4 shows a plan view of the arrangement of the turbine axle with the turbines of the preferred embodiment shown in FIG. 2; and

FIG. 5 shows a schematic perspective view of two modules of the preferred embodiment of the apparatus shown in FIG. 1.

### BEST MODES FOR CARRYING OUT THE INVENTION

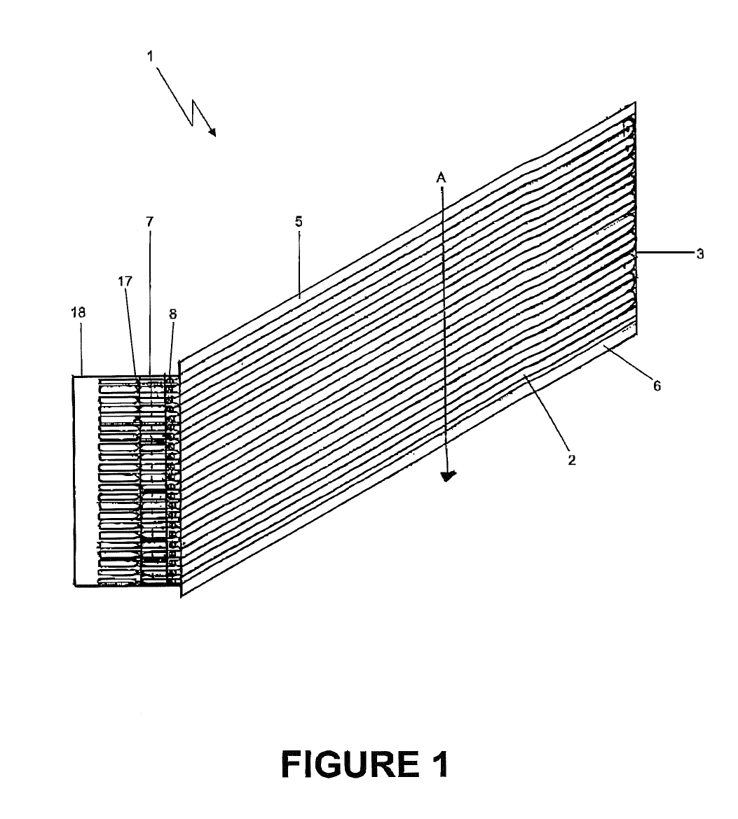

The invention is now described in relation to one preferred embodiment of the present invention as shown in FIGS. 1 to 5. It should be appreciated that the invention may be varied from the Figures without departing from the scope of the invention.

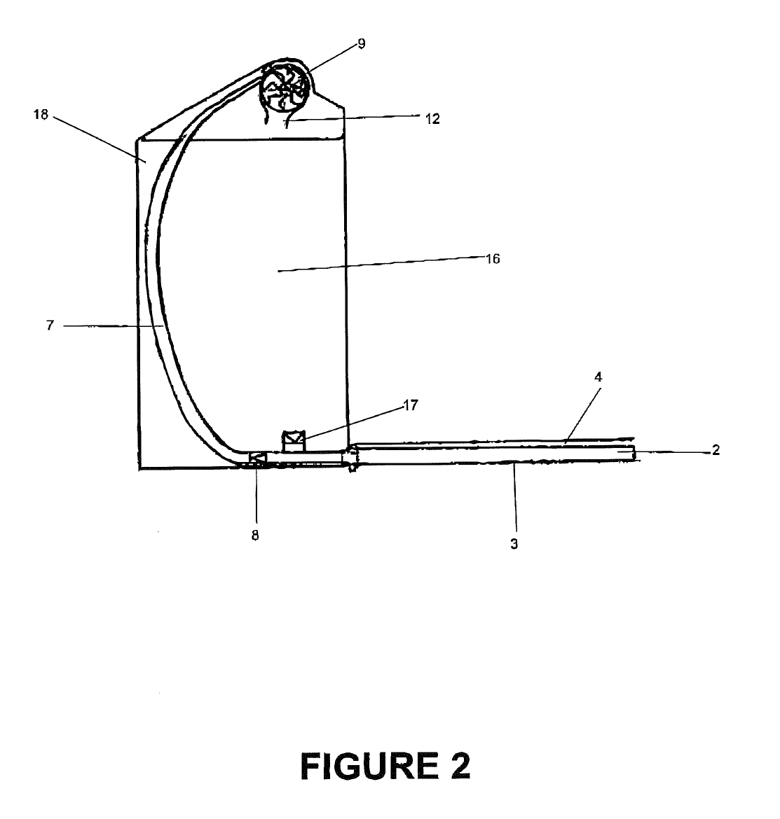

Referring to FIGS. 1 and 2, an apparatus for recovery of kinetic energy from moving wheeled vehicles is generally indicated by arrow 1. The apparatus 1 comprises a series of pressurised collapsible fluid filled pipes 2 set across a vehicle route, such as the lanes of a road or driveway. Preferably the location is chosen to ensure a high frequency of vehicles impacting the pipes 2 in the direction of arrow A. Each pipe 2 is looped back on itself to form twenty two elongate pipes 2 which are contiguously aligned and fixed to a backing mat 3 in a single flexible panel 6 m in length and 1 m in width. In preferred embodiments the backing mat 3 enables easy handling of the pipes 2 for replacement or maintenance purposes and to prevent the said pipes 2 moving from a preferred position on impact with a vehicle. The backing mat 3 sits in a cut-out or channel on the roadway which can be accessed easily for replacement or maintenance purposes. Alternatively, the backing mat 3 can sit on top of solid surface for portability.

Pipes 2 are also covered by an upper pressure sheet 4 which forms a contact surface for the wheels of a vehicle and distributes pressure laterally and longitudinally over pipes 2. In the preferred embodiment the upper pressure sheet 4 is bevelled on the approach side 5 and exit side 6 to facilitate minimal disruption to the vehicle mounting and dismounting the mat 3. The upper pressure sheet 4 is preferably made from a non-slip material such as rubber to prevent slippage of vehicles on impact.

Preferably, each of the pipes 2 are 40 mm lay-flat in cross section, as known in the art, so as to substantially collapse on direct impact with a vehicle. The pipes 2 are made from a flexible and resilient known material such as rubber or an elastomer material such as polyethylene, polyester or polypropylene. Such materials provide sufficient flexibility to enable fluid displacement through impaction (as discussed below) while also being hard wearing and relatively low cost. Other suitable materials will be apparent to those skilled in the art.

The series of pipes 2 are set at a diagonal angle of between 5° and 85°. Preferably the pipes are set at an angle of 60° from the line of travel of the vehicles indicated by arrow A. The applicant has found that this arrangement allows 80% of displaced fluid from a collapsed pipe 2 to pass to a feed line 7 and the remaining 20% to the pipe 2 loop opposite the point of impaction.

The advantage of setting the pipes 2 at a diagonal angle to the vehicle's path of direction is that optimum fluid dispersion is gained from an impact of a vehicle on the pipes 2, in terms of collapse of the pipes 2 and displacement of fluid from the pipes 2, thereby gaining optimum electrical energy from the displaced fluid in the apparatus 1 as a result of maximum contact time of the wheels of a moving vehicle with the pipes 2. The inventors have found that by placing the pipes 2 at an angle to the vehicle's path of direction an optimum recovery of electrical energy is obtained and the durability of the said pipes to the impact of vehicles is prolonged over positioning of the pipes perpendicular or parallel to the vehicle's path of direction. The pipes 2 may be varied in their dimensions, angle to vehicle path of direction and fluid pressure to optimise the apparatus 1 for a particular application.

Fluid displaced from the pipes 2 to the feed line 7 passes through a 40 mm Hansen-type one-way outlet valve 8. With the feed line 7 already charged with fluid, further fluid displaced from pipes 2 and entering the feed line 7 results in a pressure buildup in the feed line 7 due to the one-way restriction of movement by the outlet valve 8. The fluid under pressure in the feed line 7 passes to turbines 9 in line to the feed line 7 to convert the fluid displacement to mechanical movement in known fashion.

Referring to FIG. 2, once the fluid leaves the turbines 9 at outlet 12 it gravity feeds into a fluid reservoir 16 and then through a 40 mm Hansen-type one-way inlet valve 17 to recharge the pipes 2 and complete the circuit. The reservoir 16, in the form of a header tank, is positioned below the turbine 9. The reservoir 16 enables a faster rate of recharging of the collapsed pipes 2. The reservoir 16 has a pressure of substantially 8 psi to ensure quick recharging of the pipes 2. For efficient functioning of the apparatus 1 the applicants have found that the level of fluid in the reservoir must be at least 900 mm above the level of the pipes 2.

The fluid is preferably water but other non-compressible fluids could be used such as hydraulic fluid, air or Freon gas.

Preferably, each of the 22 pipe 2 pairs is fluidly connected to one outlet valve 8, turbine 9 and one inlet valve 17. An alternative (but non-preferred) arrangement to that shown is that multiple pipes 2 empty into a manifold (not shown) which then feeds the pressurised fluid from multiple pipes 2 onto a single turbine 9.

The outlet valves 8 and inlet valves 17 ensure unidirectional circulation of fluid in the fluid circuit of the apparatus 1. As an alternative to the one-way fluid circulation, the apparatus 1 may be adapted to allow two-way fluid flow, whereby the turbine 9 may rotate when the displaced fluid is forced past it and when it is sucked back when the fluid filled pipes 2 return to their original shape.

The circuit of the apparatus 1 apart from the pipes 2 is contained within a portable housing 18. The apparatus apparatus 1 may be moved from the site of in site of installation after electrical disconnection.

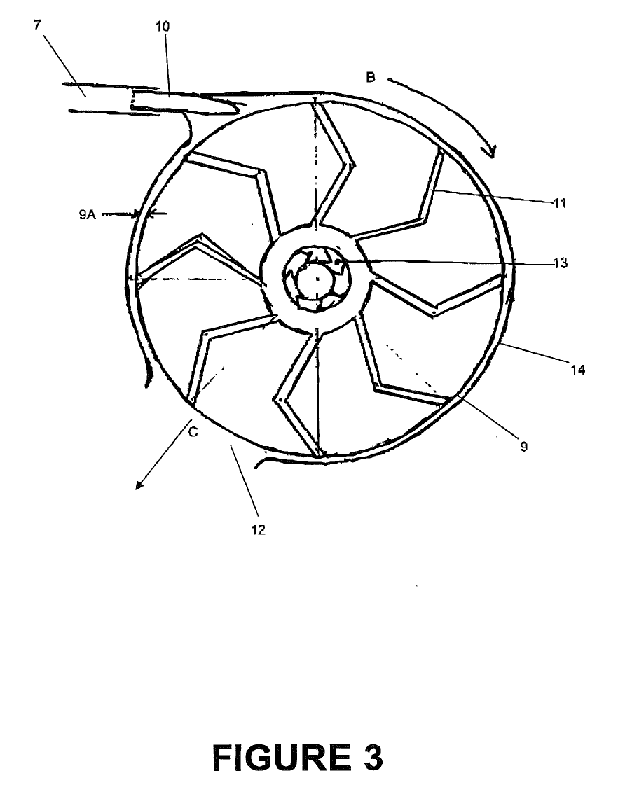

Referring to FIG. 3, the pressurised displaced fluid passes from the feed line 7 through inlet 10 to drive the spider arms 11 of the turbine 9 in the direction of arrow B. The aperture of nozzle 10 determines the pressure in the feed line 7 and the speed of turbine 9 rotation. Preferably aperture 10 is configured so that the pressure of fluid exiting the feed line 7 is 120 psi. The Applicants have found this pressure to be optimal for generating optimum fluid flow to drive the turbine. Fluid exits the turbine 9 at outlet 12 in the direction of arrow C. The turbine rotates on ratchet bearing 13. An external cover 14 ensures directional flow of fluid from inlet nozzle 10 through the turbine arms 11 to outlet 12 with minimal fluid loss. The gap 9A between the cover 14 and the turbine arms 11 is 0.3 mm which has been found by the applicant to be optimal for minimising fluid loss from the turbine.

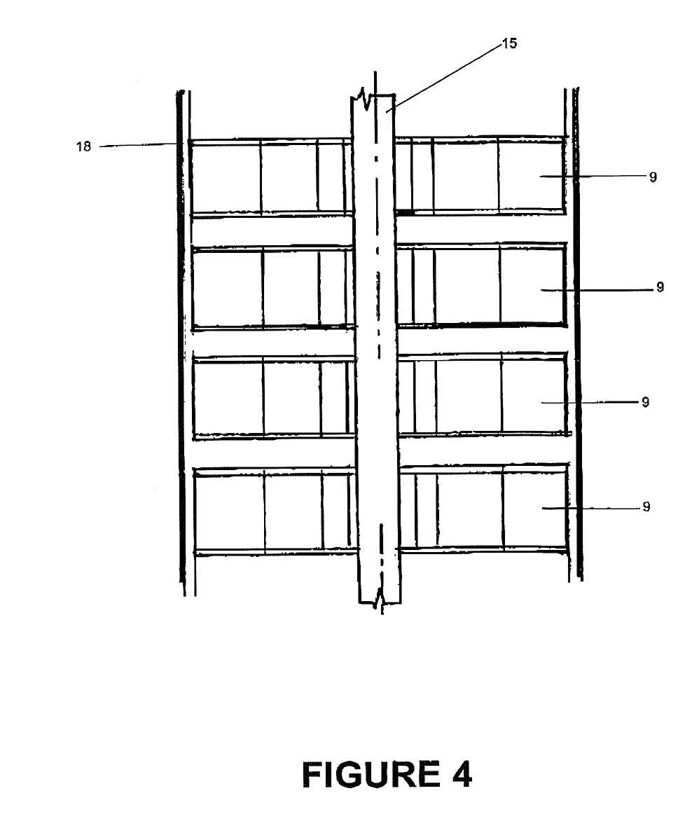

Referring to FIG. 4, multiple turbines 9 rotate on a common axle 15 inside the apparatus housing 18. The ratchet bearing 13 shown in FIG. 3 aids in rotation of the axle 15 when being driven by the fluid as know in the art. The axle 15 is connected to an integral electrical generator (not shown) to convert the mechanical rotation of the axle 15 to electricity. The electricity produced from the generator unit (not shown) is either stored on site or fed into the electricity grid in known fashion. The generator unit (not shown) has a fly-wheel (not shown) to improve electrical generation from the generator unit (not shown). The electrical generator is preferably a DC generator but alternatively can be an AC generator.

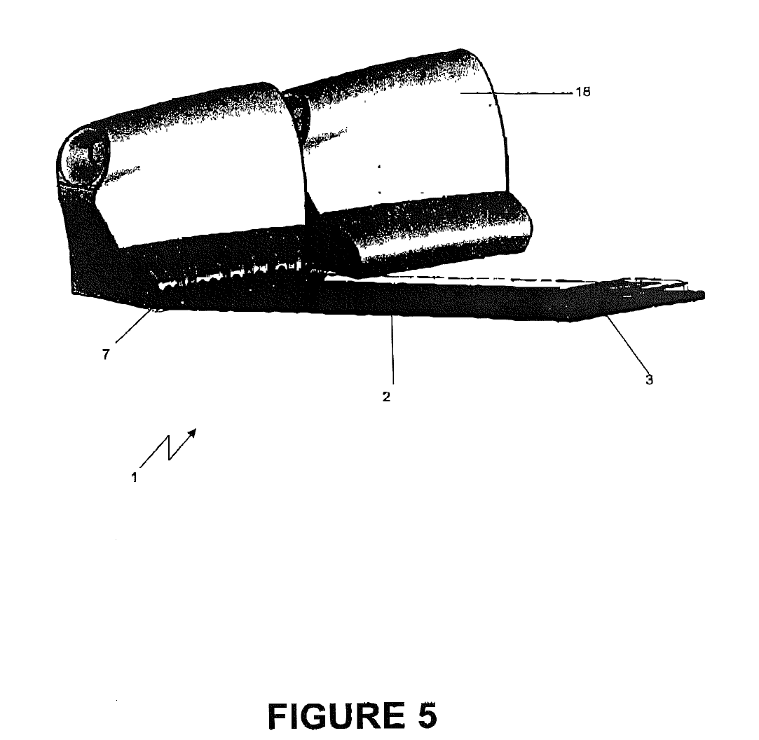

FIG. 5 shows a schematic perspective view of the apparatus 1. The backing mat 3 comprises with the pipes 2 can be disconnected from the housing 18 by disconnecting the feed lines 7 from the outlet valves 8. The apparatus 1 can form a modular system where more than one module can be electrically connected together to generate larger amounts of electricity depending on the application.

The proximity of the reservoir housing 18 to the pipes 2 provides the advantage of ensuring minimal fluid losses as the point of electrical generation is as close as possible to the point of fluid displacement.

### Example 1

The applicant has trailed the apparatus of the present invention (called the “PowerTread” apparatus) on a road highway on the Singapore-Malaysian border.

Using fluid filled pipes of 40 mm in diameter and an average vehicle tyre size of 185 mm in width impacting the pipe, with the hoses set at a 60° angle of pipe to the direction of the tyre 0.30 L (litres) of fluid was displaced per pipe. For 4 tyres per vehicle this provides 1.2 L of fluid displacement per vehicle per hose. Each module of the present invention comprised 22 fluid filled pipes this gave a total of 1.2 L×22=26.4 L of fluid displacement per module per vehicle. The average apparatus of the present invention will comprise 6 modules giving a total of 26.4 L×6 modules=158.4 L of fluid displacement per vehicle. At an average of 10 vehicles per minute the average apparatus of the present invention has been found to produce 1584 L of fluid displacement per minute or 95.03 m³ of fluid displacement/hour.

With a 10 mm diameter feed jet nozzle to the turbine the head pressure generated from the apparatus 1 is 438.00 m. With 60% efficiency from the turbine generator this equates to a net electrical energy generation of 42.11 kW per hr per mat.

Aspects of the present invention have been described by way of example only and it should be appreciated that modifications and additions may be made thereto without departing from the scope thereof as defined in the appended claims.

What we claim is:

1. An apparatus for recovery of kinetic energy from moving wheeled vehicles comprising:
at least one fluid filled pipe capable of substantially collapsing on impact with the wheels of the vehicle to provide fluid displacement;
at least one turbine for converting the fluid displacement from the at least one fluid filled pipe to mechanical movement;
a gravity feed fluid reservoir positioned above the height of the at least one fluid filled pipe;
a circuit capable of one-way fluid flow from the at least one fluid filled pipe to the at least one turbine generator unit and back to the at least one fluid filled pipe via the gravity feed fluid reservoir
wherein
the at least one fluid filled pipe is set diagonally to the vehicle's path of direction
each of the fluid filled pipe is arranged in a loop with the open ends of the pipe in direct fluid communication to the circuit.

2. An apparatus for recovery of kinetic energy from moving wheeled vehicles comprising:
at least one fluid filled pipe capable of collapsing on impact with the wheels of the vehicle to provide fluid displacement;
at least one turbine to convert the fluid displacement from the at least one fluid filled pipe to mechanical movement;
a gravity feed fluid reservoir positioned above the height of the at least one fluid filled pipe;
at least one feed line fluidly connecting the at least one fluid filled pipe to the at least one turbine;
a one-way outlet valve positioned between the at least one fluid filled pipe and the feed line;
at least one return line from the at least one turbine to the gravity feed fluid reservoir;
at least one one-way inlet valve positioned inside the gravity feed fluid reservoir and fluidly connected to the at least one fluid filled pipe
wherein
the at least one fluid filled pipe is set diagonally to the vehicle's path of direction
each of the fluid filled pipe is arranged in a loop with the open ends of the pipe in direct fluid communication to the feed line.

3. An apparatus for recovery of kinetic energy from moving wheeled vehicles as claimed in claim 1 or claim 2 wherein the apparatus also comprises at least one electrical generator to convert the mechanical movement of the turbine to electricity.

4. An apparatus for recovery of kinetic energy from moving wheeled vehicles as claimed in any one of claims 1 to 3 wherein the fluid filled pipe is a lay flat pipe.

5. An apparatus for recovery of kinetic energy from moving wheeled vehicles as claimed in any one of claims 1 to 4 wherein the fluid filled pipe is integrated into an upper pressure sheet to form a contact surface for the wheels of the vehicle and distribute the pressure of the wheels of the vehicle laterally and longitudinally over the fluid filled pipe.

6. An apparatus for recovery of kinetic energy from moving wheeled vehicles as claimed in claim 5 wherein the upper pressure sheet is made in a non-slip material.

7. An apparatus for recovery of kinetic energy from moving wheeled vehicles as claimed in any one of claims 1 to 6 wherein the fluid filled pipe is integrated into a backing mat.

8. An apparatus for recovery of kinetic energy from moving wheeled vehicles as claimed in claim 7 wherein each backing mat is integrated with twenty-two fluid filled pipes.

9. An apparatus for recovery of kinetic energy from moving wheeled vehicles as claimed in claim 7 or claim 8 wherein the backing mat also comprises an inclined plane or bevel on the approach and/or exit edge of the backing mat to facilitate mounting and/or dismounting of the vehicle from the backing mat.

10. An apparatus for recovery of kinetic energy from moving wheeled vehicles as claimed in any one of claims 1 to 9 wherein the angle between the direction of the fluid filled pipe and the vehicle's path of direction is in the range 5° to 85°.

11. An apparatus for recovery of kinetic energy from moving wheeled vehicles as claimed in claim 10 wherein the angle of direction is 60°.

12. An apparatus for recovery of kinetic energy from moving wheeled vehicles as claimed in any one of claims 1 to 11 wherein the loop of the fluid filled pipe is 6 metres in length.

13. An apparatus for recovery of kinetic energy from moving wheeled vehicles as claimed in any one of claims 1 to 12 wherein the width of the fluid filled pipe is 40 mm.

14. An apparatus for recovery of kinetic energy from moving wheeled vehicles as claimed in any one of claims 1 to 13 wherein each loop of each fluid filled pipe is fluidly connected to a feed line.

15. An apparatus for recovery of kinetic energy from moving wheeled vehicles as claimed in any one of claims 1 to 14 wherein the fluid level within the reservoir is at least 900 mm above the level of the fluid filled pipe.

16. An apparatus for recovery of kinetic energy from moving wheeled vehicles as claimed in any one of claims 1 to 14 wherein the turbines are connected by a common axle.

17. An apparatus for recovery of kinetic energy from moving wheeled vehicles as claimed in any one of claims 1 to 16 wherein the turbine, the fluid reservoir, the at least one feed line, the return line and the electrical generator are contained within a portable housing.

18. An apparatus for recovery of kinetic energy from moving wheeled vehicles as claimed in any one of claims 1 to 17 wherein the feed line fluidly connects to the turbine at a feed nozzle.

19. An apparatus for recovery of kinetic energy from moving wheeled vehicles substantially as herein described and illustrated with reference to any one of the accompanying drawings 1 to 2.
